(19) United States
(12) Patent Application Publication
(10) Pub. No.: US 2010/0059162 A1
(43) Pub. Date: Mar. 11, 2010

(54) Painter's tape for corners

(76) Inventor: Cathleen Bridget Flanigan, Peachtree, GA (US)

Correspondence Address: Michael Arnold, 114 Kirton Turn, Peachtree City, GA, 30269, US

(21) Appl. No.: 12/231,854

(22) Filed: Sep. 8, 2008

(51) Int. Cl. B32B 37/12

(52) U.S. Cl. 156/60

(57) ABSTRACT

The present invention is an improved method for applying masking tape, such as but not limited to painter's tape to surface areas wherein a 90 degree angle is encountered, such as window panes, door jambs, and corners of walls, ceilings and floors. The preferred embodiment and all alternative embodiments are comprised of easily accessed segments of material comprised of at least one 90 degree angle and releasable adhesive on part or all of the ventral aspect. The preferred embodiment and two alternative embodiments utilize a tape roll structure with the addition of perforation axes at regular intervals. The preferred embodiment and one alternative embodiment are also comprised of no adhesive zones on the ventral aspect of each tape segment. An alternative embodiment to the tape roll structure is comprised of containment of the releasable segments on a non-adhesive backing.

### CROSS-REFERENCE TO RELATED APPLICATIONS

Not applicable

### STATEMENT REGARDING FEDERALLY SPONSERED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

In 1929 Krug was issued a utility patent for masking tape that provided for paper to be applied on top of a double-sided tape, with the dorsal aspect having adhesive in a strip running the down the center of the length of tape. Masking tape is often referred to as painter's tape when used for painting a structure's interior surfaces such as walls, ceilings, window pane woodwork, and door jambs. It is used to prevent paint or another substance such as caulk or shellac from coming into contact with the surface beneath the tape. This is referred to as paint preparation work. It can be tedious work. It can require as much time and effort as applying the paint or other substance itself. The work often requires application of tape to a surface that terminates in a 90 degree angle. This presents a problem often encountered by users of the prior art in that the tape does not tear off with a straight edge. In 1988, a utility patent was issued to Brown and Sipinen for Easy-tear Masking Tape. This was a useful improvement in the art, but did not provide for a torn off segment to have a straight edge. The present invention addresses this problem. The classification of this invention is 428 masking tape.

### BRIEF SUMMARY OF THE INVENTION

The present invention, Masking Tape for Corners, is an improvement in the field of preparation work before painting or applying a similar substance such as caulk or shellac to a surface where there is adjacent surface area that the user wants to protect from contact with the paint or other substance. The present invention provides for a quick, easy, and inexpensive method of obtaining a segment of masking tape, especially the kind of masking tape known as painter's tape, that is comprised of at least one 90 degree angle, so that the tape segment can be quickly and easily applied on a surface where a 90 degree angle is encountered such as window panes, door jambs, and corners of walls, ceilings, floors, and moulding. The desired result is a significant reduction in time and energy used by the user to obtain the same end result of preventing paint or other substances from coming in contact with adjacent surface area. The preferred embodiment is a modification of a prior art roll of masking tape, wherein axes of small perforations separate the segments and a no adhesive zone encompassing the perforation axis and a margin on either side of the perforation axis allow the user to manually tear off a segment of tape along the perforation axis. The result is a straight edge along the tear line of the perforation axis that was easy for the user to obtain. The user then manually applies the 90 degree angle of tape over the surface area with the 90 degree angle. The present invention does not replace the prior art masking tape because the user will need to utilize the prior art tape for the portions of the surface area that do not have 90 degree requirements such as the majority of a wall to be painted, between two corners or endpoints of the wall. The cost of manufacture is believed to be low because the modifications to the tape: the perforation axis and the no adhesive zone entail manufacturing procedures that are currently practiced and inventor believes to be uncomplicated. If the perforations are to be made through mechanical means, the inventor believes the two modifications and the application of adhesive to the ventral substrate outside of the no adhesive zone can be accomplished simultaneously. If the perforations are done by higher tech means, such as laser technology, the procedure is still believed to be inexpensive.

Several alternative embodiments of the invention are provided. All are variations in form providing the same function. There is one alternative that has larger implications however. In the alternative embodiment entailing simply adding the perforation axis to the prior art of masking tape, without the no adhesive zone, there is the possibility of this form completely replacing the prior art for painter's tape. The reason that this embodiment is not the preferred embodiment is that the inventor is unsure of two considerations: the perforations must not leak paint through to the surface area, and the tape must tear with a straight edge which might not occur if adhesive is surrounding the perforation axis. The inventor has attempted to test these considerations, but without access to laser technology, this testing remains inconclusive. So, the choice of the embodiment to be offered to the user is a marketing decision. The alternative embodiments that use the non-adhesive backing have an appeal in that they do not present the obstacle of the perforations making the edge less than 100 percent straight, but they entail the added trash of the non-adhesive backing after use. The alternative embodiments that use the idicium to direct the user to the side or corner of the tape segment to be applied over the 90 degree surface area have the benefit of using less adhesive than the preferred embodiment, although this form requires the user to take an extra moment to ensure that he or she is following this procedure. If the cost of adhesive is a priority consideration for the manufacturer, this might be the most desirable embodiment for them.

### BRIEF DESCRIPTION OF THE SEVERAL VIEW

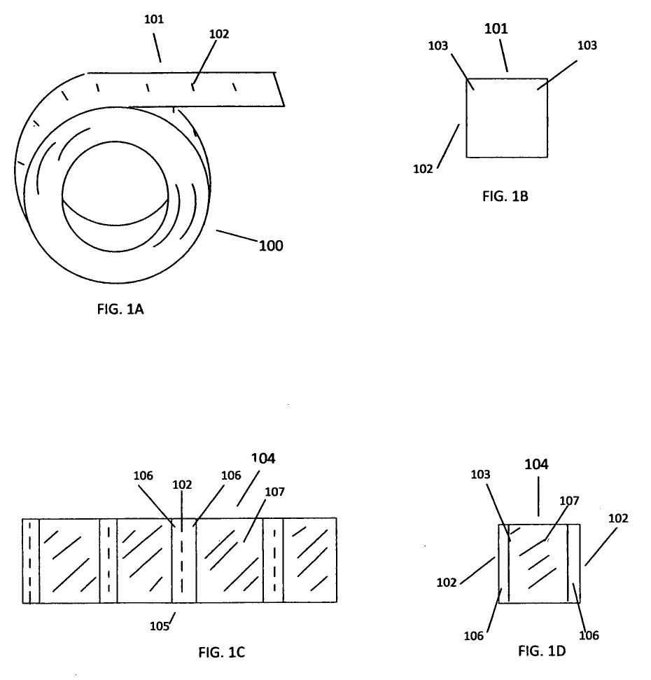

FIG. 1A depicts an overhead perspective of a roll of masking tape of the prior art with exceptionalities which comprise the preferred embodiment of the present invention.

FIG. 1B depicts the dorsal aspect of one segment of tape separated from the roll depicted in FIG. 1A.

FIG. 1C depicts the ventral aspect of the preferred embodiment of the invention while still attached to the roll, with roll not shown. A zone of no adhesion comprised of a perforation axis and a margin on each side of the perforation axis extending the width of the tape for an equal distance in opposing directions from the perforation axis is shown.

FIG. 1D depicts the ventral aspect of one segment of tape separated from the length of tape depicted in FIG. 1C.

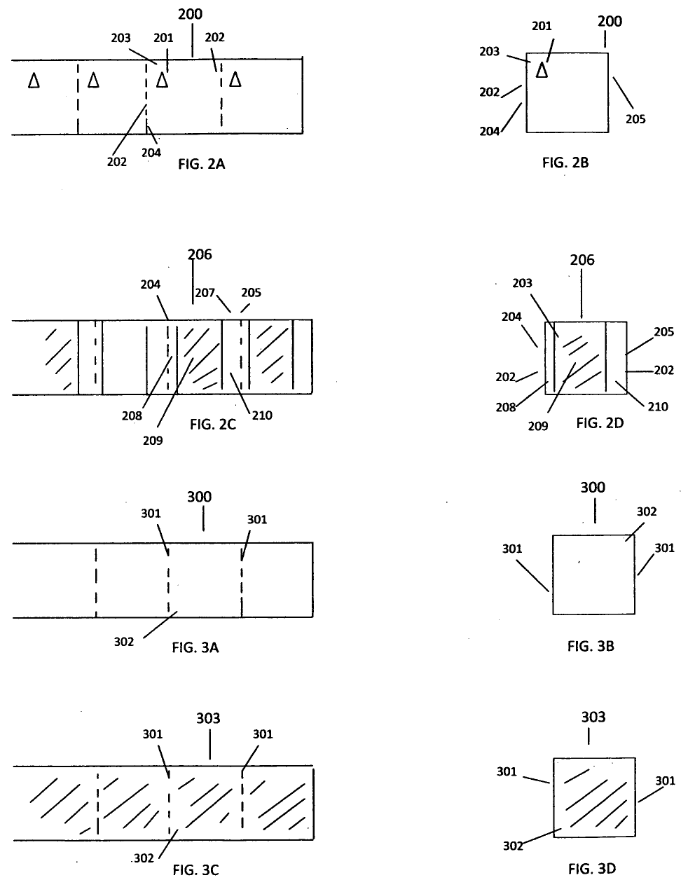

FIG. 2A depicts the dorsal aspect of a length of masking tape while still attached to the roll, with roll not shown, of an alternative embodiment of the present invention. Indicia are located on the dorsal aspect of the tape in order to identify for the user the side of the segment to be applied onto the surface area where the 90 degree angle requirement exists.

FIG. 2B depicts the dorsal aspect of one segment of tape separated from the length of tape depicted in FIG. 2A.

FIG. 2C depicts the ventral aspect of an alternative embodiment of the invention, the same as 2A and 2B, while still attached to the roll, with roll not shown. A zone of no adhesion is comprised of a perforation axis and two margins of unequal distance in opposing directions from the perforation axis. FIG. 2D depicts the ventral aspect of one segment of tape separated from the length of tape depicted in FIG. 2C.

FIG. 3A depicts the dorsal aspect of a length of masking tape while still attached to the roll, with roll not shown, of an alternative embodiment of the present invention. A perforation axis which extends the width of the tape is utilized by the user to separate a segment of tape from the roll.

FIG. 3B depicts the dorsal aspect of one segment of tape separated from the length of tape depicted in FIG. 2A.

FIG. 3C depicts the ventral aspect of the embodiment of the invention in FIG. 3A while still attached to the roll, with roll not shown.

FIG. 3D depicts the ventral aspect of one segment of tape separated from the length of tape depicted in FIG. 3C.

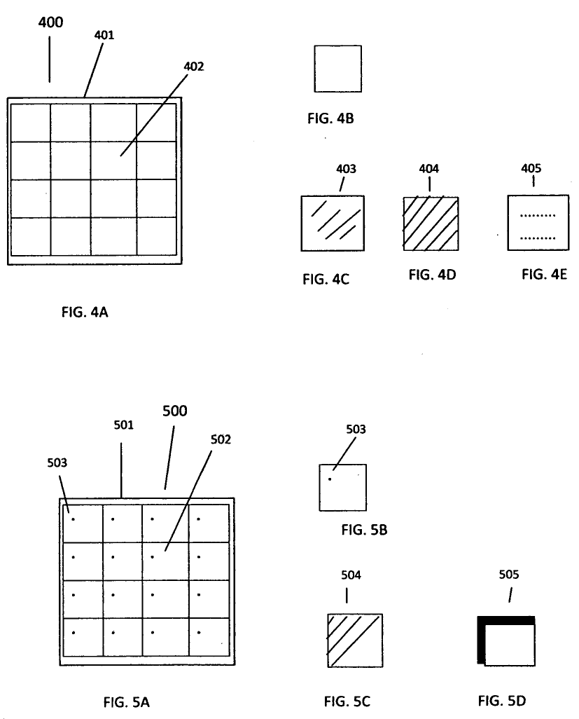

FIG. 4A depicts an overhead perspective of an alternative embodiment of the present invention comprised of a plurality of separate tape segments mounted in adjacent formation on a backing paper with a non-adhesive dorsal surface to allow for release of the tape segments.

FIG. 4B depicts an overhead perspective of the dorsal aspect of one tape segment from FIG. 4A.

FIG. 4C depicts an overhead perspective of the ventral aspect of one tape segment from FIG. 4A with the adhesive covering the entirety of the ventral stratum.

FIG. 4D and FIG. 4E are examples of adhesive patterns as possible alternatives to covering the entirety of the ventral stratum as depicted in FIG. 4C.

FIG. 5A depicts an overhead perspective of an alternative embodiment of the present invention comprised of a plurality of separate tape segments mounted in adjacent formation on a backing paper with a non-adhesive dorsal surface to allow for release of the tape segments. An indicium is printed on the portion of the segment that will be fitted to the 90 degree surface area by the user.

FIG. 5B depicts an overhead perspective of the dorsal aspect of one tape segment from FIG. 5A.

FIG. 5C and FIG. 5D are examples of possible adhesive patterns for the ventral stratum of the alternative embodiment depicted in FIGS. 5A and 5B.

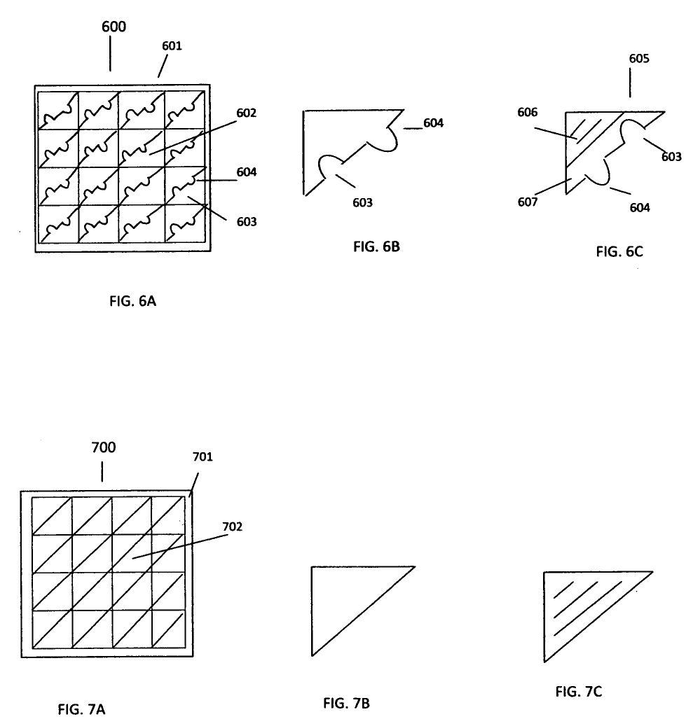

FIG. 6A depicts an overhead perspective of an alternative embodiment of the present invention comprised of a plurality of separate tape segments mounted in adjacent formation on a backing paper with a non-adhesive dorsal surface to allow for release of the tape segments. A tab is provided to facilitate tape segment removal from the backing surface as well as from the surface on which it was used. A tab recess is a design element to provide for adjacent formation on the backing.

FIG. 6B depicts an overhead perspective of the dorsal aspect of one tape segment from FIG. 6A.

FIG. 6C depicts an overhead perspective of the ventral aspect of one tape segment from FIG. 6A.

FIG. 7A depicts an overhead perspective of an alternative embodiment of the present invention comprised of a plurality of separate tape segments, each segment being comprised of a right triangle, mounted in adjacent formation on a backing paper with a non-adhesive dorsal surface to allow for release of the tape segments.

FIG. 7B depicts an overhead perspective of the dorsal aspect of one tape segment from FIG. 7A.

FIG. 7C depicts an overhead perspective of the ventral aspect of one tape segment from FIG. 7A.

### DETAILED DESCRIPTION OF THE INVENTION

FIG. 1A depicts a roll of masking tape 100 of the prior art with exceptionalities which comprise the preferred embodiment of the present invention. The composition of the materials used for the tape strata, the composition of the adhesive, and the composition of the inner core of the roll are prior art. The dorsal aspect of the tape while still attached to the body of tape is depicted by 101. A perforation axis 102 which extends the width of the tape, is utilized by the user to separate a segment of tape from the roll, as depicted in FIG. 1B and FIG. 1D. The 90 degree angles of the tape segment 103 enable the user to prepare for painting adjacent to a surface with multiple 90 degree angles such as multiple rooms comprised of corners at ceilings and floors, door jambs, moulding corners, and window pane corners with significant reduction in time, energy, and stress compared to the present method of tearing off tape that does not tear off with a straight edge. FIG. 1C depicts the ventral aspect of the preferred embodiment of the invention while still attached to the roll, with roll not shown. A zone of no adhesion 105 is comprised of a perforation axis 102 and a margin 106 on each side of the perforation extending the width of the tape. These margins 106 are of equal distance in opposing directions from the perforation axis 102. An adhesion zone 107 is comprised of the length of tape between two margins that does not have a perforation axis 102. FIG. 1D depicts a separated segment of tape of the same ventral aspect 104 as depicted in FIG. 1C.

FIG. 2A depicts the dorsal aspect 200 of a length of masking tape while still attached to the roll, with roll not shown, of an alternative embodiment of the present invention. Indicia 201, comprised of any identifying mark such as a trademark or a simple dot is located on the dorsal aspect of the tape, near the trailing edge 204 of the length of tape, in order to identify for the user the side of the segment to be applied onto the surface area where the 90 degree angle requirement exists. The leading edge 205 of the length of tape is the side of the segment which has the larger margin of no adhesive on the ventral aspect as depicted in FIG. 2C and FIG. 2D. A perforation axis 202 which extends the width of the tape, is utilized by the user to separate a segment of tape from the roll, as depicted in FIG. 2B and FIG. 2D. The 90 degree angles of the tape segment 203 enable the user to prepare for painting adjacent to a surface with multiple 90 degree angles such as multiple rooms comprised of corners at ceilings and floors, door jambs, moulding corners, and window pane corners with significant reduction in time, energy, and stress compared to the present method of tearing off tape that does not tear off with a straight leading edge. FIG. 2B depicts a separated segment of tape of the same dorsal aspect as depicted in FIG. 2A. FIG. 2C depicts the ventral aspect 206 of the same embodiment of the invention as FIG. 2A and FIG. 2B while still attached to the roll, with roll not shown. A zone of no adhesion 207 is comprised of a perforation axis 202 and a margin on each side of the perforation 208 and 210 extending the width of the tape. These margins are of unequal distance in opposing directions from the perforation axis 102. 208 indicates the proximal margin. It is close to the trailing edge 204 perforation 202. 210 indicates the distal margin. It is closer to the leading edge 205 of the tape. An adhesion zone 209 is comprised of the length of tape between two margins that does not have a perforation axis 202. FIG. 2D depicts a separated segment of tape of the same ventral aspect 206 as depicted in FIG. 2C.

FIG. 3A depicts the dorsal aspect 300 of a length of masking tape while still attached to the roll, with roll not shown, of an alternative embodiment of the present invention. The composition of the materials used for the tape strata, the composition of the adhesive, and the composition of the inner core of the roll are prior art. A perforation axis 301 extends the width of the tape and is utilized by the user to separate a segment of tape from the roll, as depicted in FIG. 3B and FIG. 3D. The 90 degree angles of the tape segment 302 enable the user to prepare for painting adjacent to a surface with multiple 90 degree angles such as multiple rooms comprised of corners at ceilings and floors, door jambs, moulding corners, and window pane corners with significant reduction in time, energy, and stress compared to the present method of tearing off tape that does not tear off with a straight leading edge as well as tear off tape with more than one segment along its length for use on surfaces where a 90 degree angle is not required. This is not the preferred embodiment of the invention at this time because there are two requirements to meet for this embodiment to be usable: an effort by the user to tear off a portion of tape along a perforated axis must result in a clean, easy tear; and the substance to be blocked by the tape must not be able to seep through the perforations of the axes. This inventor believes that the perforations must be made to the tape after the adhesive has been applied to the ventral substrate and dried if the perforations are to fully penetrate the tape. The inventor believes that the perforations could be done by mechanical means by puncturing the tape or by more high tech means such as precise lasers. If the latter method is used by the manufacturer, the laser might be calibrated to not fully penetrate the ventral substrate. This might be sufficient to meet the previously stated requirements: a clean tear, and blocking of substances to the surface beneath the tape. Inventor has no means of testing tape with lasers. Inventor has attempted to test puncturing tape via a homemade tool comprising an array of needles, but test results have been inconclusive. FIG. 3C depicts the ventral aspect of the embodiment of the invention in FIG. 3A while still attached to the roll, with roll not shown. FIG. 3D depicts a separated segment of tape of the same ventral aspect 303 as depicted in FIG. 3C.

FIG. 4A depicts an overhead perspective 400 of an alternative embodiment of the present invention comprised of a plurality of separate tape segments mounted in adjacent formation 402 on a backing paper with a non-adhesive dorsal surface 401 to allow for release of the tape segments. FIG. 4B depicts the dorsal aspect of one tape segment. FIG. 4C depicts the ventral aspect of one tape segment with adhesive on the entirety of this surface 403. FIG. 4D and FIG. 4E are examples of adhesive patterns as possible alternatives to covering the entirety of the ventral stratum as depicted in FIG. 4C. FIG. 4D is comprised of a stripe pattern 404 and FIG. 4E is comprised of a dot pattern 405.

FIG. 5A depicts an overhead perspective 500 of an alternative embodiment of the present invention comprised of a plurality of separate tape segments mounted in adjacent formation 502 on a backing paper with a non-adhesive dorsal surface 501 to allow for release of the tape segments. An indicium 503 is printed on the portion of the segment that will be fitted to the 90 degree surface area by the user. FIG. 5B depicts the dorsal aspect of one tape segment. FIG. 5C depicts the ventral aspect of one tape segment with adhesive on a portion of the tape, in this example, forming a right angle triangle in a stripe pattern 504 correspondent with the indicium on the dorsal side of the segment 503, as depicted in FIG. 5B. FIG. 5D depicts the ventral aspect of one tape segment with adhesive on a portion of the tape, in this example, forming a right angle comprised of two bands of adhesive 505.

FIG. 6A depicts an overhead perspective 600 of an alternative embodiment of the present invention comprised of a plurality of separate tape segments mounted in adjacent formation 602 on a backing paper with a non-adhesive dorsal surface 601 to allow for release of the tape segments. A tab 604 is provided to facilitate tape segment removal from the backing surface as well as from the surface on which it was used. A tab recess 603 is a design element to provide for adjacent formation 602 on the non-adhesive backing. FIG. 6B depicts the dorsal aspect of one tape segment. FIG. 6C depicts the ventral aspect 605 of one tape segment with adhesive on a portion of the tape, in this example forming a right angle triangle 606. A no-adhesive zone 607 on the tab portion of the segment provides ease of removal from the backing or other surface for the user.

FIG. 7A depicts an overhead perspective 700 of an alternative embodiment of the present invention comprised of a plurality of separate tape segments mounted in adjacent formation 702 on a backing paper with a non-adhesive dorsal surface 701 to allow for release of the tape segments. FIG. 7B depicts the dorsal aspect of one tape segment. FIG. 7C depicts the ventral aspect of one tape segment 703 with adhesive on the entirety of this surface.

What is claimed is:

1. An improved method of applying masking tape, such as but not limited to painter's tape, to a surface comprised of a 90 degree angle, comprising:
A segment of masking tape of pre-determined length, such as but not limited to comprising a square, of the type suitable for preventing paint, caulk, or similarly used substances from coming in contact with the surface area beneath the tape, such as but not limited to painter's tape, and comprising at least one 90 degree angle,
a roll of masking tape from which said tape segment is to be obtained, comprised of tape materials of prior art regarding composition of the adhesive substance and composition of the non-adhesive materials, with the exceptions that the masking tape has axes of perforations in regular intervals perpendicular to the length of the tape, such as but not limited to such interval distances to comprise a square when one tape segment is removed from the tape roll through manual tearing along the perforation axis and a zone of no adhesive on the ventral stratum along each perforation axis and on either side of said perforation axis for a predetermined equal length of tape on either side of said axis, such as but not limited to ⅛ of an inch on either side, the termination of said zones of no adhesive comprising margins,
manual removal of a tape segment from said tape roll by manually tearing along said perforation axis, and
manual application of said tape segment onto the desired surface area.

2. The improved method of applying masking tape, such as but not limited to painter's tape, to a surface comprised of a 90 degree angle of claim 1 wherein said masking tape segments are of a predetermined length, such as but not limited to comprising a square.

3. The improved method of applying masking tape, such as but not limited to painter's tape, to a surface comprised of a 90 degree angle of claim 1 wherein said masking tape segment is comprised of at least one 90 degree angle.

4. The improved method of applying masking tape, such as but not limited to painter's tape, to a surface comprised of a 90 degree angle of claim 1 wherein said masking tape segments have axes of perforations in regular intervals perpendicular to the length of the tape.

5. The improved method of applying masking tape, such as but not limited to painter's tape, to a surface comprised of a 90 degree angle of claim 1 wherein said masking tape segments have no adhesive on the ventral stratum along each perforation axis.

6. The improved method of applying masking tape, such as but not limited to painter's tape, to a surface comprised of a 90 degree angle of claim 1 wherein said masking tape segments are comprised of a zone of no adhesive on the ventral stratum along each perforation axis and on either side of said perforation axis.

7. The improved method of applying masking tape, such as but not limited to painter's tape, to a surface comprised of a 90 degree angle of claim 1 wherein said masking tape segments are comprised of a zone of no adhesive on the ventral stratum along each perforation axis and on either side of said perforation axis for a predetermined length of tape on either side of said axis, such distances of adhesive omission being equal on each side of said perforation axis, such as but not limited to ⅛ of an inch on either side, the termination of said zones of no adhesive comprising margins.

8. An improved method of applying masking tape, such as but not limited to painter's tape, to a surface comprised of a 90 degree angle, comprising:
A segment of masking tape of pre-determined length, such as but not limited to comprising a square, of the type suitable for preventing paint, caulk, or similarly used substances from coming in contact with the surface area beneath the tape, such as but not limited to painter's tape, and comprising at least one 90 degree angle,
a roll of masking tape from which said tape segment is to be obtained, comprised of tape materials of prior art regarding composition of the adhesive substance and composition of the non-adhesive materials, with the exceptions that the masking tape has axes of perforations in regular intervals perpendicular to the length of the tape, such as but not limited to such interval distances to comprise a square when one tape segment is removed from the tape roll through manual tearing along the perforation axis and a zone of no adhesive on the ventral stratum along each perforation axis and on either side of said perforation axis for a predetermined unequal length of tape on either side of said axis, the termination of said zones of no adhesive comprising margins consisting of a proximal margin which is relatively closer to said perforation axis and a distal margin which is relatively further from the perforation axis,
manual removal of a tape segment from said tape roll by manually tearing along said perforation axis, and
manual application of said tape segment onto the desired surface area.

9. The improved method of applying masking tape, such as but not limited to painter's tape, to a surface comprised of a 90 degree angle of claim 8 wherein an indicium is applied to the dorsal aspect of the masking tape above the proximal margin side of the no adhesive zone.

10. An improved method of applying masking tape, such as but not limited to painter's tape, to a surface comprised of a 90 degree angle, comprising:
A segment of masking tape of pre-determined length, such as but not limited to comprising a square, of the type suitable for preventing paint, caulk, or similarly used substances from coming in contact with the surface area beneath the tape, such as but not limited to painter's tape, and comprising at least one 90 degree angle,
a roll of masking tape from which said tape segment is to be obtained, comprised of tape materials of prior art regarding composition of the adhesive substance and composition of the non-adhesive materials, with the exceptions that the masking tape has axes of perforations in regular intervals perpendicular to the length of the tape, such as but not limited to such interval distances to comprise a square when one tape segment is removed from the tape roll through manual tearing along the perforation axis
manual removal of a tape segment from said tape roll by manually tearing along said perforation axis, and
manual application of said tape segment onto the desired surface area.

11. An improved method of applying masking tape, such as but not limited to painter's tape, to a surface comprised of a 90 degree angle, comprising:
a plurality of releasable segments of masking tape of pre-determined length, such as but not limited to comprising a square, of the type suitable for preventing paint, caulk, or similarly used substances from coming in contact with the surface area beneath the tape, such as but not limited to painter's tape, and comprising at least one 90 degree angle, aligned in adjacent formation on a non-adhesive backing, such as but not limited to coated paper.
manual removal of a tape segment from said non-adhesive backing paper by manually holding said non-adhesive backing paper with one hand and peeling off the tape segment with the other hand, and
manual application of said tape segment onto the desired surface area.

12. An alternative embodiment of the present invention of an improved method of applying masking tape, such as but not limited to painter's tape, to a surface comprised of a 90 degree angle of claim 11 wherein an indicium is applied to the dorsal aspect of each releasable segment in the 90 degree portion of the segment that is to be applied to the 90 degree angle of the surface area on which said segment is to be applied.

13. An alternative embodiment of the present invention of an improved method of applying masking tape, such as but not limited to painter's tape, to a surface comprised of a 90 degree angle of claim 11 wherein a tab comprised of an extension of material with no adhesive applied to it extends away from the 90 degree angle portion of the segment that is to be applied to the 90 degree angle of the surface area on which the segment is to be applied.

14. An alternative embodiment of the present invention of an improved method of applying masking tape, such as but not limited to painter's tape, to a surface comprised of a 90 degree angle of claim 11 wherein a tab recess comprised of a gap in the segment material extends in a direction opposite to that of the tab of claim 13 for the purpose of aligning a greater quantity of segments in adjacent formation on a small surface area of non-adhesive backing.

15. An alternative embodiment of the present invention of an improved method of applying masking tape, such as but not limited to painter's tape, to a surface comprised of a 90 degree angle of claim 11 wherein adhesive is applied to the ventral aspect of the segment in a non-contiguous pattern such as but not limited to rows of dots or stripes.
